(19) United States
(12) Patent Application Publication
(10) Pub. No.: US 2012/0087658 A1
(43) Pub. Date: Apr. 12, 2012

(54) Wavelength Selective Switch Band Aggregator and Band Deaggregator and Systems and Methods Using Same

(75) Inventor: Ralph Brian Jander, Freehold, NJ (US)

(73) Assignee: TYCO ELECTRONICS SUBSEA COMMUNICATIONS LLC, Morristown, NJ (US)

(21) Appl. No.: 12/902,740

(22) Filed: Oct. 12, 2010

(51) Int. Cl. H04J 14/02; H04J 14/00

(52) U.S. Cl. 398/48; 398/89

(57) ABSTRACT

In general, wavelength division multiplexed (WDM) communication systems may use wavelength selective switching to aggregate and/or deaggregate groups or bands of channel wavelengths. A wavelength selective switch (WSS) band aggregator may combine a plurality of channel band aggregate optical signals to produce a combined aggregate optical signal (i.e., a transmitted WDM or DWDM signal). The WSS band aggregator may also combine one or more spectral portions of broadband noise with the bands of channel wavelengths such that the spectral portion(s) of the broadband noise occupies unutilized channels in the combined aggregate optical signal. A WSS band deaggregator may separate a combined aggregate optical signal (i.e., a received WDM or DWDM signal) to produce a plurality of channel band aggregate optical signals.

### TECHNICAL FIELD

The present application relates to the optical transmission of information and more particularly, to the use of wavelength selective switching to combine and/or separate bands of channel wavelengths in an optical communication system and method.

### BACKGROUND

Optical communication systems employ wavelength combining techniques known as wavelength division multiplexing (WDM) or dense wavelength division multiplexing (DWDM) to multiplex many transmission channels onto a single-mode fiber. An optical communication system generally includes line terminating equipment (LTE) capable of transmitting and receiving the WDM or DWDM signals at the end of an optical fiber cable. In transoceanic optical communications systems, for example, the LTE provides the optical interface between the inland terrestrial network and the wet-plant optical cable system. The LTE may include transponders, dispersion compensation equipment, multiplexers, de-multiplexers and optical amplifiers for transmitting and receiving the WDM or DWDM signals.

A portion of the LTE, known as wavelength terminating equipment (WTE), may provide functions such as optical dispersion compensation, channel aggregation/deaggregation and receive-signal amplified spontaneous emission (ASE) filtering. The WTE may include tunable and bulk dispersion compensation devices, arrayed waveguide grating (AWG) multiplexers and de-multiplexers, and terminal line amplifiers (TLA).

In some optical communications systems, the transmission channels or wavelengths are grouped together in several bands. For practical reasons, it may be preferable to restrict the number of constituent channels multiplexed by each AWG in the WTE (e.g., to 8 or 16 channels). Grouping smaller bands of channels also enables use of bulk dispersion devices on the individual bands. Thus, the LTE or WTE may include transponders grouped together in bands with wavelength multiplexing components, terminal line amplifiers and bulk dispersion compensation, forming a subsystem that produces aggregate optical signals for each of the bands. In such systems, broadband couplers are often used to aggregate or combine the aggregate signals produced by each of the band subsystems to form a combined aggregate optical signal (i.e., the WDM or DWDM signal to be transmitted on the optical path). In some systems, the bands of channels are combined along with loading tones or noise provided by initial loading equipment (ILE) on unutilized channels, for example, to provide optical power management across the spectrum of the WDM or DWDM signal.

When broadband couplers are used to aggregate the channel bands, group filters are used before the bands are combined on the transmit side and after the bands are separated on the receive side. On the transmit path, the group filters increase the optical signal to noise ratio (OSNR) of the data channels. The group filters are often thin film filters that have a pass band just large enough to pass the data channels associated with a particular group. The filtering is performed when combining the groups with a broadband coupler to prevent noise away from the channels being combined from adding on top of data channels from other groups. On the receive path, the group filters enable the secondary TLA to realize more power among signals associated with an individual band rather than delivering gain to channels that will eventually be stripped later by the AWGs, which pass only a small portion of the total transmission channels. When using the group filters, however, several different group filter pass bands might be required to support multiple different channel plans (e.g., with 25, 33.33 and 50 GHz channel spacing). The group filters also may not adequately isolate each of the LTE bands from ASE noise in adjacent bands, resulting in a reduction in OSNR.

### BRIEF DESCRIPTION OF THE DRAWINGS

Reference should be made to the following detailed description which should be read in conjunction with the following figures, wherein like numerals represent like parts:

FIG. 1 is a simplified block diagram of one exemplary embodiment of a wavelength division multiplexed (WDM) communication system using a wavelength selective switch (WSS) band aggregator and deaggregator, consistent with the present disclosure;

FIG. 2 is a simplified block diagram of one exemplary embodiment of line terminating equipment (LTE) using a WSS band aggregator and deaggregator, consistent with the present disclosure.

FIG. 3 is a simplified block diagram of one exemplary embodiment of a WSS band aggregator consistent with the present disclosure.

FIG. 4 is a simplified block diagram of one exemplary embodiment of a redundant WSS band aggregator with protection switching consistent with the present disclosure.

FIG. 4A is a simplified block diagram of another exemplary embodiment of a redundant WSS band aggregator with protection switching consistent with the present disclosure.

### DETAILED DESCRIPTION

In general, wavelength division multiplexed (WDM) communication systems, consistent with embodiments described herein, may use wavelength selective switching to aggregate and/or deaggregate groups or bands of channel wavelengths. A wavelength selective switch (WSS) band aggregator may aggregate or combine a plurality of channel band aggregate optical signals to produce a combined aggregate optical signal (i.e., a transmitted WDM or DWDM signal). The WSS band aggregator may also combine one or more spectral portions of broadband noise with the bands of channel wavelengths such that the spectral portion(s) of the broadband noise occupies unutilized channels in the combined aggregate optical signal. A WSS band deaggregator may deaggregate or separate a combined aggregate optical signal (i.e., a received WDM or DWDM signal) to produce a plurality of channel band aggregate optical signals.

As used herein, “wavelength selective switching” refers to switching optical signals to one or more outputs on a per-wavelength basis. The term “coupled” as used herein refers to any connection, coupling, link or the like by which signals carried by one system element are imparted to the “coupled” element. Such “coupled” devices are not necessarily directly connected to one another and may be separated by intermediate components or devices that may manipulate or modify such signals.

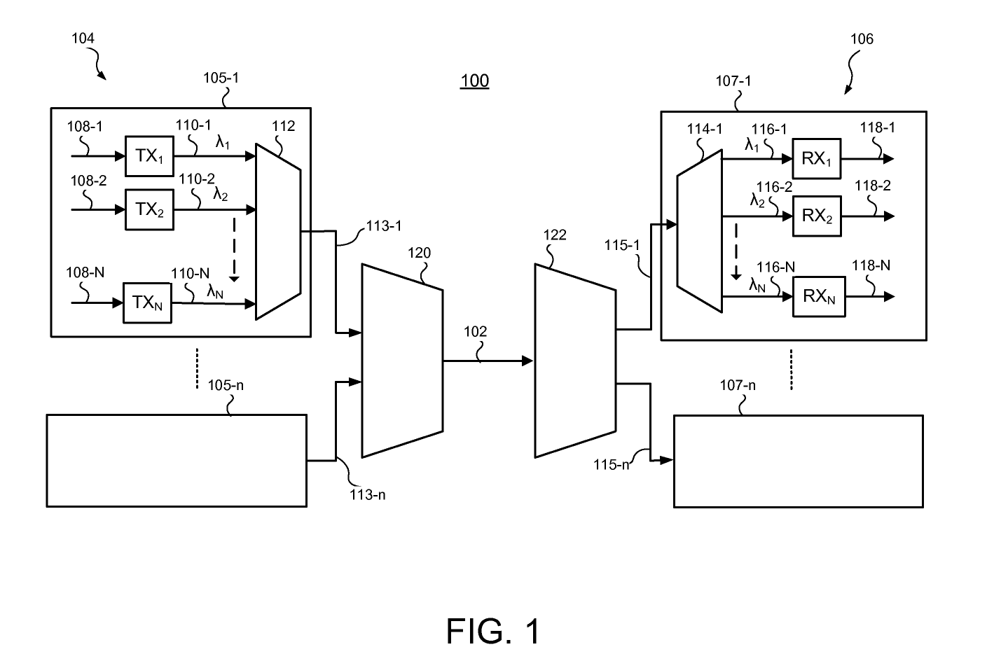

FIG. 1 is a simplified block diagram of one exemplary embodiment of a WDM communication system 100, consistent with the present disclosure, which uses wavelength selective switching to combine and separate bands of transmission channel wavelengths. The communication system 100 serves to transmit a plurality of optical channels over an optical path 102 from a transmitting terminal 104 to one or more remotely located receiving terminals 106. The exemplary system 100 may be a long-haul submarine system configured for transmitting the channels from a transmitter to a receiver, for example, at a distance of 5,000 km, or more. Wavelength selective switching, consistent with the present disclosure, may also be used in other optical communication systems such as terrestrial systems configured for transmitting from a transmitter to a receiver, for example, at distances in a range of about 2,000 km to 3,000 km.

Those skilled in the art will recognize that the communication system 100 has been depicted as a highly simplified point-to-point system for ease of explanation. For example, the transmitting terminal 104 and receiving terminal 106 may both be configured as transceivers or transponders, whereby each may be configured to perform both transmitting and receiving functions. For ease of explanation, however, the terminals are depicted and described herein with respect to only a transmitting or receiving function. The illustrated exemplary embodiments herein are provided only by way of explanation, not of limitation.

The optical channels (e.g., 1, 2, . . . N) may be established based on a plurality of corresponding optical carrier wavelengths (e.g., λᵢ, λ₂ . . . λ_{N}) such that each channel has a spectral width centered on the respective carrier wavelength (or frequency). As used herein, channel wavelengths refer to the wavelengths associated with the respective channels and may include a range of wavelengths centered on the carrier wavelength associate with a channel. The channel wavelengths may be grouped into multiple bands to facilitate transmitting and receiving WDM signals including the combined channel wavelengths. A first band of channels 1, 2, . . . N, for example, may include channel wavelengths λ₁, λ₂ . . . λ_{N} and a second band of channels N+1, . . . N+M may include channel wavelengths λ_{N+1}, . . . λ_{N+M}. The number of bands may range from, for example, 1 to 6 depending upon the desired system bandwidth (i.e., channel capacity) and channel spacing. Various different groupings of wavelengths are possible to provide various numbers of channel bands.

Channels carrying information signals may also be referred to as utilized channels. Channels without information signals, referred to as unutilized channels, may be used as loading channels to maintain uniform spectral power density in the aggregate transmit signal. A loading signal may include a non-information carrying signal such as noise, e.g. (amplified spontaneous emission) ASE noise, or a dummy tone. Dummy tones generally refer to optical energy that is centered on a specific wavelength, which does not carry information or traffic.

In the exemplary embodiment (FIG. 1), the WDM communication system 100 is a dense wavelength division multiplexed (DWDM) system having high spectral efficiencies, i.e., where the spectral width of constituent frequency carriers is larger than the actual frequency spacing among constituents. In exemplary embodiments, the channels may have a spacing of 33 GHz or 25 GHz and the spectral efficiency may be 0.6 bit/s/Hz or 0.8 bit/s/Hz.

The transmitting terminal 104 includes transmitting subsystems 105-1, 105-n for each of the n bands of channel wavelengths. In the illustrated exemplary embodiment, for example, a plurality of transmitters TX₁, TX₂ . . . TX_{N} receive data on respective data paths 108-1, 108-2 . . . 108-N and transmit respective optical signals by modulating the data on respective optical carrier wavelengths λ₁, λ₂ . . . λ_{N} associated with transmission channels (i.e., 1, 2, . . . N) within a first band of channel wavelengths. Data may be modulated on the channel wavelengths λ₁, λ₂ . . . λ_{N} using various modulation formats such as a differential phase shift keying (DPSK) modulation format, e.g. a RZ-DPSK or CRZ-DPSK format. The transmitters are shown in highly simplified form for ease of explanation. Each transmitter may include electrical and optical components configured for transmitting the optical signal at its associated wavelength with a desired amplitude and modulation.

The transmitted channel wavelengths (λ₁, λ₂ . . . λ_{N}) within the first band are respectively carried on a plurality of optical paths 110-1, 110-2 . . . 110-N and a multiplexer 112 combines the channel wavelengths within the associated band to form a channel band aggregate optical signal on an optical path 113-1. The transmitting subsystem 105-n for one or more additional bands may similarly include transmitters and a multiplexer (not shown) for combining the channel wavelengths associated with the band to produce a channel band aggregate optical signal on an optical path 113-n.

A WSS band aggregator 120 then combines the channel band aggregate signals to produce a combined aggregate optical signal (i.e., a WDM or DWDM signal) on the optical path 102. The WSS band aggregation multiplexer 120 may include one or more wavelength selective switches, as described in greater detail below, to selectively switch wavelengths in the channel band aggregate signals received on the inputs coupled to optical paths 113-1, 113-n to a common output coupled to the optical path 102. The optical path 102 may include optical fibers, waveguides, optical amplifiers, optical filters, dispersion compensating modules, and other active and passive components.

The combined aggregate optical signal launched onto the optical path 102 may be received at a remote receiving terminal 106. The remote receiving terminal 106 includes receiving subsystems 107-1, 107-n for each of the n bands of channel wavelengths. A WSS band deaggregator 122 separates the combined aggregated optical signal received on the optical path 102 into a plurality of channel band aggregate optical signals, each including channel wavelengths within each of the respective bands. The WSS band deaggregator 122 may include one or more wavelength selective switches, as described in greater detail below, to selectively switch wavelengths in the combined aggregate signal received on the input coupled to the optical path 102 to the outputs coupled to optical paths 115-1, 115-n. The optical paths 115-1, 115-n carry the respective channel band aggregate optical signals to the respective receiving subsystems 107-1, 107-n.

In the illustrated exemplary embodiment, a demultiplexer 114-1 separates the channels at channel wavelengths λ₁, λ₂ . . . λ_{N} in the first channel band aggregate signal onto associated paths 116-1, 116-2 . . . 116-N coupled to associated channel receivers RX₁, RX₂ . . . RX_{N}. The receivers RX₁, RX₂ . . . RX_{N} may be configured to demodulate the optical signals on the separated channels and provide associated output data signals on respective output data paths 118-1, 118-2 . . . 118-N. The receivers are shown in highly simplified form for ease of explanation. Each receiver may include electrical and optical components configured for receiving and demodulating the optical signal at its associated wavelength.

Using wavelength selective switching in the aggregator 120 and deaggregator 122 enables narrow band combining and/or splitting and avoids the need for the group filters used to reduce noise when combining and separating channel bands with broadband couplers. Using wavelength selective switching further provides flexibility for use with various channel plans.

Although the exemplary embodiment of the optical communication system 100 uses wavelength selective switching to combine and separate the channel band aggregate optical signals, an optical communication system 100 may use wavelength selective switching to only combine or only separate channel band aggregate optical signals. In other embodiments, for example, either the WSS band aggregator 120 or the WSS band deaggregator 122 may be a broadband coupler or other similar device capable of combining or separating bands of channel wavelengths.

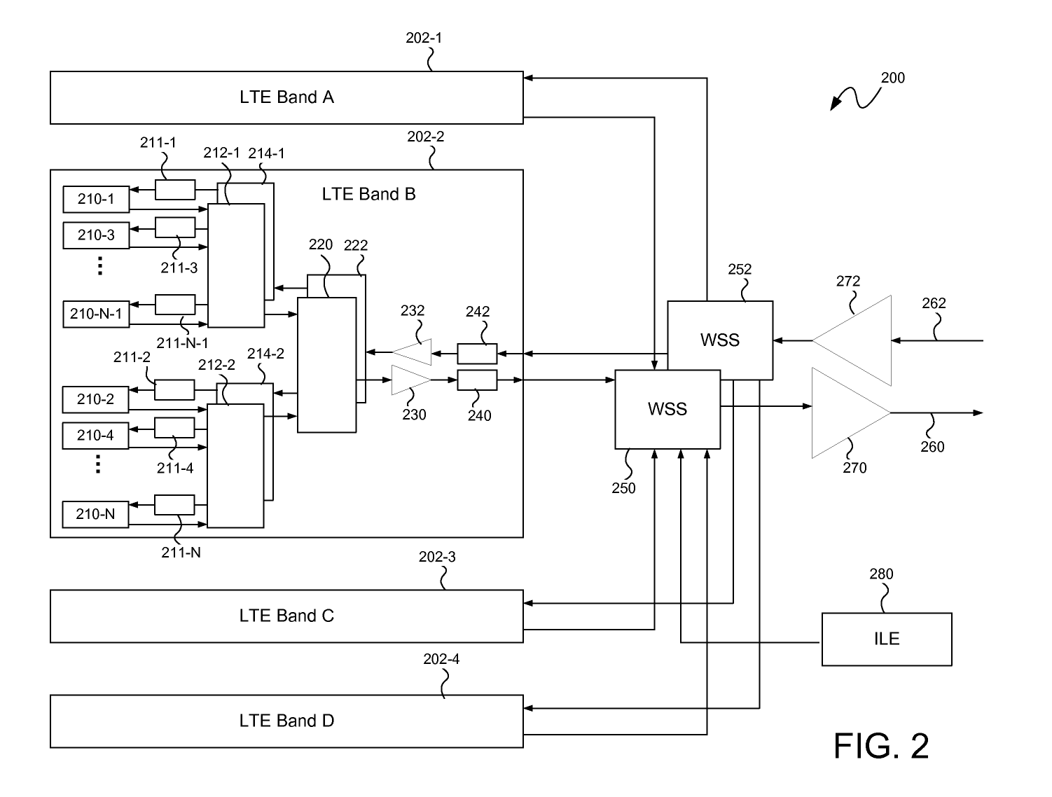

FIG. 2 is a simplified block diagram of one exemplary embodiment of line terminating equipment (LTE) 200 for both transmitting and receiving WDM signals, consistent with the present disclosure, which uses wavelength selective switching to combine and separate channel band aggregate optical signals. The LTE 200 includes wavelength terminating equipment (WTE) 202-1 to 202-4 for each of the bands of channel wavelengths (e.g., bands A to D). The WTE 202-1 to 202-4 includes the equipment for combining and separating the channel wavelengths within each of the respective bands.

In this embodiment, the channel wavelengths within each band A to D are further grouped based on odd channels (1, 3, . . . N−1) and even channels (2, 4, . . . N) such that the odd and even channels are combined with orthogonal polarizations to produce the respective channel band aggregate optical signal. One example of combining odd and even channels with orthogonal polarizations is described in greater detail in U.S. patent application Ser. No. 12/831,477, filed on Jul. 7, 2010, which is fully incorporated herein by reference. Although the exemplary embodiments described herein refer to odd and even channels, other groupings of channels (with corresponding sets of channel wavelengths) with orthogonal polarizations may be possible with transmitters, receivers, multiplexers, demultiplexers and other components configured for those other groupings of channels.

Referring to one of the channel bands (i.e., band B), the WTE 202-2 includes odd channel transponders 210-1, 210-3 . . . 210-N−1 and even channel transponders 210-2, 210-4 . . . 210-N, which combine the transmitter and receiver functionality. In one example, each band provides 32 channels—16 odd channels and 16 even channels. The WTE 202-2 also provides wavelength division multiplexing and demultiplexing of the channel wavelengths associated with the transponders in each band. On the transmit side, an odd channel wavelength multiplexer 212-1 (or combiner) and an even channel wavelength multiplexer 212-2 (or combiner) receive optical signals from the transponders and combine the odd channel wavelengths and the even channel wavelengths, respectively, to provide aggregate optical signals. On the receive side, an odd channel wavelength demultiplexer 214-1 and an even channel wavelength demultiplexer 214-2 separate the odd channel wavelengths and the even channel wavelengths, respectively, for processing the odd channel and even channel optical signals in the transponders. The multiplexers 212-1, 212-2 and demultiplexers 214-1, 214-2 may include AWG devices such as 16×1 AWG devices to provide multiplexing and/or demultiplexing for 16 channels. Tunable dispersion compensation (TDC) devices 211-1, 211-2 . . . 211-N may also be located in the receive paths before the receiver portion of each of the transponders to provide per channel dispersion compensation. TDC devices (not shown) may also be included in the transmit paths.

The WTE 202-2 further combines and separates the group of odd channel wavelengths and the group of even channel wavelengths. On the transmit side, a combiner or multiplexer 220 combines the aggregate odd channel signal and the aggregate even channel signal to provide a channel band aggregate optical signal. On the receive side, a demultiplexer 222 separates the odd channel wavelengths from the even channel wavelengths. In one embodiment, the multiplexer 220 may include an orthogonally-combining interleaving filter multiplexer that simultaneously pre-filters and combines the aggregate odd channel signal and the aggregate even channel signal with substantially orthogonal polarization to provide a pre-filtered, pair-wise orthogonal aggregate signal, for example, as described in U.S. patent application Ser. No. 12/831,477, which is incorporated herein by reference. The transmit side and receive side within the WTE 202-2 may further include terminal line amplifiers 230, 232 and bulk dispersion compensation equipment 240, 242.

On the transmit side, the LTE 200 may further include a WSS band aggregator 250 for combining the channel band aggregate optical signals associated with the bands (e.g., bands A to D) to produce a combined aggregate optical signal for transmission over an optical path 260. The WSS band aggregator 250 selectively switches the channel wavelengths in the channel band aggregate optical signals received on inputs to the aggregator 250 to a common output of the aggregator 250. On the receive side, the LTE 200 may also include a WSS band deaggregator 252 for separating the combined aggregate optical signal received on an optical path 362 into channel band aggregate optical signals associated with the respective bands. The WSS band deaggregator 252 selectively switches the channel wavelengths in the combined aggregate optical signal received on an input to the deaggregator 252 to the appropriate outputs of the deaggregator 252 to produce the separated channel band aggregate optical signals. In other embodiments, a broadband optical coupler and group filters may be used instead of either the WSS band aggregator 250 or the WSS band deaggregator 252.

The LTE 200 may further include initial loading equipment (ILE) 280 for loading unutilized channels with noise. The ILE 280 may include a broadband noise source that provides broadband noise such as amplified spontaneous emission (ASE) noise. The WSS band aggregator 250 selectively switches at least one spectral portion of the broadband noise to the common output of the aggregator such that the spectral portion(s) occupies unutilized channels in the combined aggregate optical signal. By performing wavelength selective switching, the WSS band aggregator 250 allows the ILE 280 to provide broadband noise (e.g., instead of loading tones at specific wavelengths) and provides more flexibility when loading unutilized channels for power management.

The LTE 200 may further include terminal line amplifiers (TLA) 270, 272 for amplifying the transmitted combined aggregate optical signal before transmission over the optical path 260 and for amplifying the received combined aggregate optical signal received on the optical path 262.

The WSS band aggregator 250 and/or the WSS band deaggregator 252 may include one or more wavelength selective switches with sufficient spectral resolution to operate on the given channel plan (e.g., channel spacing) of the optical communication system. The wavelength selective switches may include a single common optical port and opposing multi-wavelength ports where each channel wavelength can be switched or routed between any of the ports independent of how the other wavelengths are routed. In one embodiment, the WSS band aggregator 250 and/or the WSS band deaggregator 252 may include a single 1×n WSS that allows any channel wavelength received on a common port to be routed or steered to (or from) any one of the opposing n ports. Where a single 1×n WSS is used, the number of n ports corresponds to the number of bands being combined (including the broadband noise). For the LTE 200 with Bands A to D and noise loading, for example, the WSS band aggregator 250 and/or WSS band deaggregator 252 may include a 1×5 WSS.

Although the exemplary embodiment shows inputs to the WSS band aggregator 250 for each of the bands A to D, other embodiments may combine one or more subsets of the bands (e.g., non-adjacent bands) prior to the WSS band aggregator 250 such that the WSS may have fewer input ports than the number of bands. For example, the channel band aggregate optical signals for Bands A and C may be combined and the channel band aggregate optical signals for Bands B and D may be combined, and a 1×3 WSS may be used to combine the two combined channel band aggregate optical signals and the noise.

In other embodiments, a WSS band aggregator and/or a WSS band deaggregator may include a combination of wavelength selective switches having formats such as 1×1, 1×2, 1×4, etc. In a system with Bands A to D, for example, a first 1×2 WSS may be used to combine two of the bands and a second 1×2 WSS may be used to combine the other two of the bands. The outputs of the first 1×2 WSS and the second 1×2 WSS may then be combined to produce the combined aggregate optical signal.

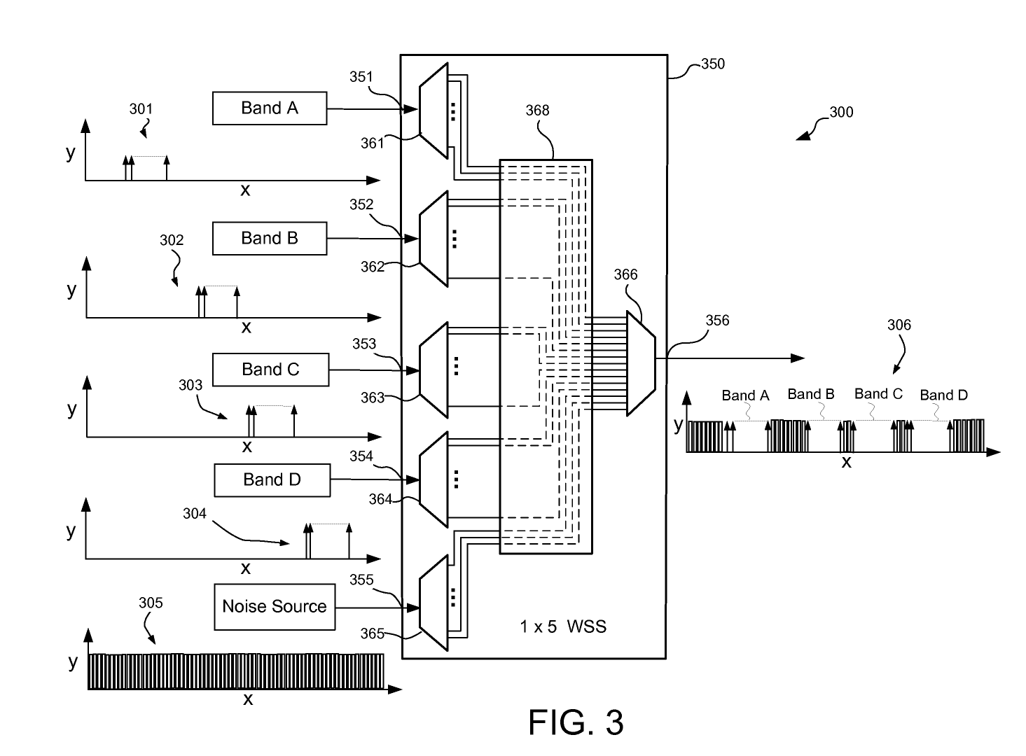

FIG. 3 is a simplified block diagram of one exemplary embodiment of a WSS band aggregator 300, consistent with the present disclosure, which may be used in a system with four (4) channel bands A to D and noise loading. The WSS band aggregator 300 includes a 1×5 wavelength selective switch 350 with five (5) input ports 351-354 and one common output port. The input ports 351-354 receive respective channel band aggregate optical signals for respective bands A to D and the input port 355 receives the broadband noise from a broadband noise source.

As illustrated, each of the bands A to B and the broadband noise provide different spectral inputs to the WSS 350 with Band A having spectrum 301, Band B having spectrum 302, Band C having spectrum 303, Band D having spectrum 304 and the noise having broadband spectrum 305. The WSS 350 selectively switches wavelengths from each of the optical signals received on inputs 301-304 and from the noise received on input 306 to a common output port 356 such that the different input spectrums 301-305 are assembled into an aggregate output spectrum 306. As shown in this exemplary embodiment, spectral portions of the noise spectrum 305 may be selectively switched to the output port 356 such that the noise is loaded on unutilized channels between the bands A to D.

The WSS 350 may include wavelength demultiplexers 361-365 (e.g., AWGs) for separating the band channel aggregate optical signals into the constituent wavelengths, a switching fabric 368 for selectively routing the constituent wavelengths, and a wavelength multiplexer 366 (e.g., an AWG) for multiplexing the selectively routed wavelengths into the combined aggregate optical signal. The wavelength provisioning in the WSS 350 may be dynamic and may be controlled through a digital communication interface (not shown) on the WSS. The switching fabric 368 may be implemented using various technologies including, without limitation, liquid crystal on silicon (LCOS) and digital light processing (DLP).

The WSS 350 may also be capable of adjusting optical power levels in one or more of the constituent wavelengths that are selectively switched by the WSS 350. The WSS 350 may include, for example, variable optical attenuators (VOAs) to provide adjustable attenuation levels to any of the wavelengths. The WSS 350 may thus provide power pre-emphasis of selected channels in the combined aggregate optical signal, for example, to achieve a desired pre-emphasis profile across the spectrum of the combined aggregate optical signal. Providing pre-emphasis in the WSS 350 reduces or eliminates the reliance on the transmitters and/or TLAs for pre-emphasis.

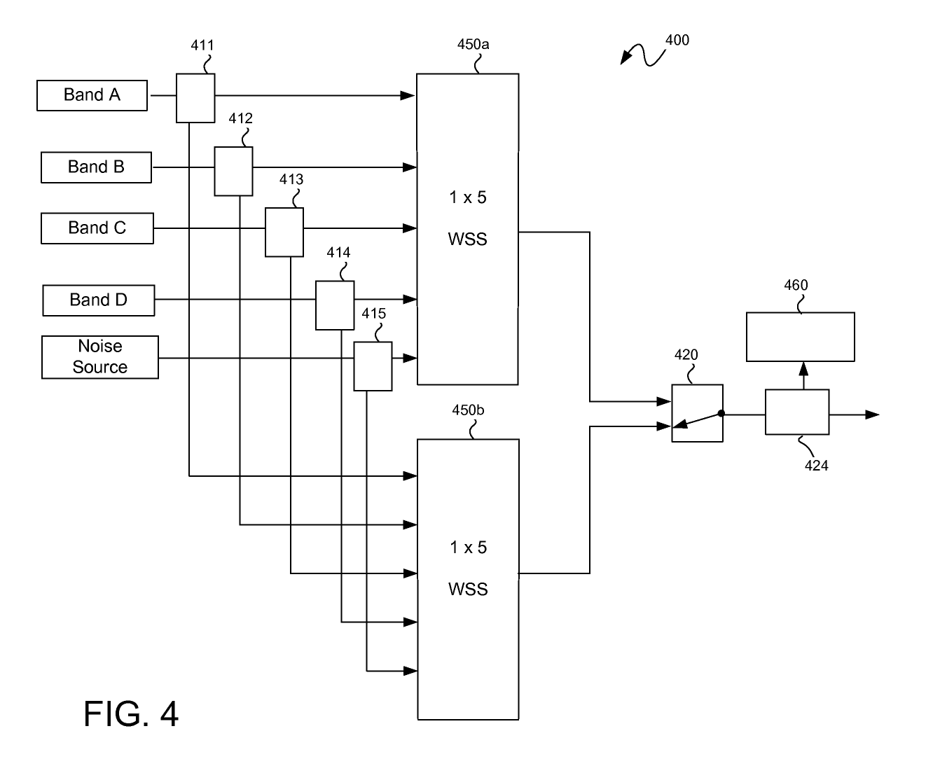

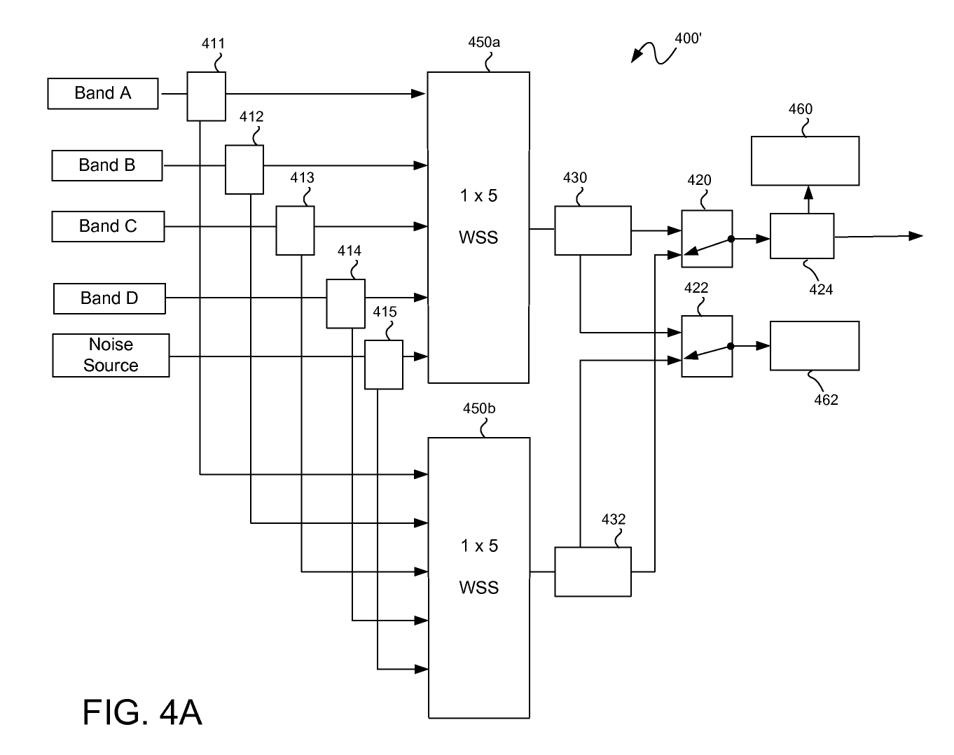

FIG. 4 is a simplified block diagram of another exemplary embodiment of a WSS band aggregator 400, consistent with the present disclosure, with redundancy and protection switching to improve reliability. The exemplary WSS band aggregator 400 includes redundant 1×5 wavelength selective switches 450a, 450b. Each of the 1×5 wavelength selective switches 450a, 450b includes five input ports for receiving the respective channel band aggregate optical signals and the broadband noise and one output port for providing the combined aggregate optical signal. The WSS band aggregator 400 includes splitters 411-415 (e.g., 3 dB splitters) for splitting the channel band aggregate optical signals and broadband noise signal and providing redundant inputs to the respective redundant wavelength selective switches 450a, 450b. The redundant wavelength selective switches 450a, 450b are thus capable of providing redundant combined aggregate optical signals.

The WSS band aggregator 400 also includes at least one protection switch 420 capable of switching between the redundant outputs of the wavelength selective switches 450a, 450b. In response to a failure of one of the redundant wavelength selective switches 450a, 450b, for example, the protection switch 420 may switch from the output of the failed wavelength selective switch to the output of the other operational wavelength selective switch, thereby replacing the failed WSS. Although the protection switch 420 is shown coupled to the outputs of the wavelength selective switches 450a, 450b, other embodiments may include a protection switch located in each of the wavelength selective switches 450a, 450b to switch from a failed WSS to an operational WSS. In other embodiments, other methods may be used to “turn off” a failed WSS and “turn on” a replacement WSS.

The WSS band aggregator 400 may include a fault detection system for detecting a failure in one or both of the wavelength selective switches 450a, 450b. The fault detection system may include, for example, optical spectral monitoring (OSM) or pilot tone detection capable of detecting a problem at the output of the redundant wavelength selective switches 450a, 450b. As shown in FIG. 4, for example, a splitter 424 (e.g., a 10 dB splitter) may split the output from the protection switch 420 such that a fault detector 460 can monitor the output, for example, using pilot tone detection. In other embodiments, the fault detection may be performed within the wavelength selective switches 450a, 450b.

FIG. 4A shows another embodiment of a WSS band aggregator 400′ including a fault detection system. In this embodiment, the WSS band aggregator 400′ includes splitters 430, 432 (e.g., 10 dB splitters) after each of the redundant wavelength selective switches 450a, 450b to split the respective outputs from the wavelength selective switches 450a, 450b. The exemplary WSS band aggregator 400′ also includes two protection switches 420, 422 for switching between the outputs of the splitters 430, 432. One protection switch 420 provides the switching from the output of the failed WSS to the replacement WSS. The other protection switch 422 may switch the outputs of the wavelength selective switches 450a, 450b to an OSM 462 for monitoring optical spectra in the selected output to detect a problem.

If the pilot tone detector 460 or the OSM 462 detects an error that is indicative of a failure of the WSS providing the output, the protection switch 420 switches to the output of the operational WSS and replaces the failed WSS. Other fault detection systems may also be used to detect the failure of one of the wavelength selective switches 450a, 450b. The redundant WSS architectures described in connection with the WSS band aggregators 400, 400′ may also be implemented in WSS band deaggregators to provide similar fault protection on the receive side.

Although some presently available wavelength selective switches include associated electronics that provide a failure in time (FIT) rate in the range of 500 to 2000, the use of the redundant architecture with protection switching allows that FIT rate to be reduced, for example, closer to FIT rates achievable when passive optics are used to provide band aggregation. According to another embodiment, a wavelength selective switch may include a hot swappable redundant electronics control module that is capable of reducing the FIT rate.

Accordingly, the use of wavelength selective switching to combine channel band optical signals provides reconfigurable filtering to support a variety of channel plans, increases the launch OSNR, allows flexible broadband noise loading, and allows flexible power pre-emphasis.

Consistent with one embodiment, an optical transmission method includes: modulating a plurality of data streams on a plurality of channel wavelengths, respectively, to produce a plurality of optical signals on respective channels, wherein the plurality of channel wavelengths are grouped in a plurality of bands; combining the optical signals modulated on the channel wavelengths in each of the plurality of bands, respectively, to produce a plurality of channel band aggregate optical signals, each of the channel band aggregate optical signals including channel wavelengths of an associated one of the bands; and combining the plurality of channel band aggregate optical signals to produce a combined aggregate optical signal by using wavelength selective switching to route the channel wavelengths in each of the channel band aggregate optical signals to a common output, the combined aggregate optical signal including the channel wavelengths in the plurality of bands.

Consistent with another embodiment, an optical transmitting system includes a plurality of band transmitting subsystems for producing channel band aggregate optical signals. Each of the band transmitting subsystems is configured to modulate a plurality of data streams on a plurality of channel wavelengths, respectively, to produce a plurality of optical signals on respective channels within an associated band and being configured to combine the optical signals modulated on the channel wavelengths in the associated band to produce a respective one of the channel band aggregate optical signals. The optical transmitting system also includes at least one wavelength selective switch (WSS) band aggregator configured to receive the channel band aggregate optical signals on a plurality of inputs, respectively, and configured to combine the channel band aggregate optical signals to produce a combined aggregate optical signal by using wavelength selective switching to route channel wavelengths in each of the channel band aggregate optical signals received on the plurality of inputs to a common output of the WSS band aggregator. The combined aggregate optical signal includes the channel wavelengths in the plurality of bands.

Consistent with a further embodiment, a line terminating equipment (LTE) system is provided for receiving and transmitting combined aggregate optical signals. The LTE system includes: a plurality of transponders configured to transmit and receive optical signals modulated on channel wavelengths, wherein the plurality of channel wavelengths are grouped in a plurality of bands; a plurality of multiplexers configured to combine transmitted optical signals modulated on the channel wavelengths in respective ones of the bands to produce a plurality of transmitted channel band aggregate optical signals; a plurality of demultiplexers configured to separate a plurality of received channel band aggregate optical signals, respectively, into received optical signals modulated on the channel wavelengths in respective ones of the bands; at least one wavelength selective switch (WSS) band aggregator configured to combine the transmitted channel band aggregate optical signals to produce a transmitted combined aggregate optical signal by using wavelength selective switching to route channel wavelengths in each of the transmitted channel band aggregate optical signals to an output, the transmitted combined aggregate optical signal including the channel wavelengths in the plurality of bands; and at least one wavelength selective switch (WSS) band deaggregator configured to separate a received combined aggregate optical signal into the plurality of received channel band aggregate optical signals by using wavelength selective switching to route channel wavelengths in the received combined aggregate optical signal to a plurality of outputs.

Consistent with yet another embodiment, an optical communication system includes a transmitting terminal configured to transmit a combined aggregate optical signal on a plurality of optical channels within a plurality of bands. The transmitting terminal includes a wavelength selective switch (WSS) band aggregator configured to receive channel band aggregate optical signals on a plurality of inputs, respectively, each of the channel band aggregate optical signals including a plurality of channel wavelengths within an associated one of the bands. The WSS band aggregator is also configured to combine the channel band aggregate optical signals to produce a combined aggregate optical signal by using wavelength selective switching to route channel wavelengths in each of the channel band aggregate optical signals received on the plurality of inputs to an output of the WSS band aggregator. The combined aggregate optical signal including the channel wavelengths in the plurality of bands. The optical communication system also includes a receiving terminal configured to receive the combined aggregate optical signal. The receiving terminal includes a wavelength selective switch (WSS) band deaggregator configured to separate the combined aggregate optical signal into the plurality of channel band aggregate optical signals by using wavlength selective switching to route channel wavelengths in the combined aggregate optical signal to a plurality of outputs. The optical communication system further includes an optical transmission path coupling the transmitting terminal and the receiving terminal.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

1. An optical transmission method comprising:
modulating a plurality of data streams on a plurality of channel wavelengths, respectively, to produce a plurality of optical signals on respective channels, wherein the plurality of channel wavelengths are grouped in a plurality of bands;
combining the optical signals modulated on the channel wavelengths in each of the plurality of bands, respectively, to produce a plurality of channel band aggregate optical signals, each of the channel band aggregate optical signals including channel wavelengths of an associated one of the bands; and
combining the plurality of channel band aggregate optical signals to produce a combined aggregate optical signal by using wavelength selective switching to route the channel wavelengths in each of the channel band aggregate optical signals to a common output, the combined aggregate optical signal including the channel wavelengths in the plurality of bands.

2. The method according to claim 1 further comprising:
noise loading the combined aggregate optical signal by using wavelength selective switching to route at least one spectral portion of broadband noise to the output, wherein the spectral portion of the broadband noise occupies at least one unutilized channel in the combined aggregate optical signal.

3. The method according to claim 2 wherein the wavelength selective switching is performed by a 1×n wavelength selective switch (WSS), wherein n corresponds to the number of bands being combined.

4. The method according to claim 1 wherein the wavelength selective switching is performed by a plurality of wavelength selective switches.

5. The method according to claim 1, wherein the wavelength selective switching is performed by at least one wavelength selective switch (WSS), further comprising:
monitoring the WSS to detect a failure of the WSS; and
switching to a replacement WSS in response to detecting the failure of the WSS.

6. The method according to claim 5, wherein monitoring the WSS includes monitoring the combined aggregate signal output from the WSS.

7. The method according to claim 1 further comprising:
adjusting a power level of at least one of the channel wavelengths including the optical signals or at least one unutilized channel wavelength loaded with noise when routing the wavelengths.

8. An optical transmitting system comprising:
a plurality of band transmitting subsystems for producing channel band aggregate optical signals, each of the band transmitting subsystems being configured to modulate a plurality of data streams on a plurality of channel wavelengths, respectively, to produce a plurality of optical signals on respective channels within an associated band and being configured to combine the optical signals modulated on the channel wavelengths in the associated band to produce a respective one of the channel band aggregate optical signals; and
at least one wavelength selective switch (WSS) band aggregator configured to receive the channel band aggregate optical signals on a plurality of inputs, respectively, and configured to combine the channel band aggregate optical signals to produce a combined aggregate optical signal by using wavelength selective switching to route channel wavelengths in each of the channel band aggregate optical signals received on the plurality of inputs to a common output of the WSS band aggregator, the combined aggregate optical signal including the channel wavelengths in the plurality of bands.

9. The optical transmitting system of claim 8 wherein each of the band transmitting subsystems comprises:
a plurality of transmitters configured to modulate the plurality of data streams on the plurality of channel wavelengths, respectively, to produce the plurality of optical signals on respective channels within the associated band; and
a multiplexer configured to combine the optical signals modulated on the channel wavelengths in the associated band to produce the respective one of the channel band aggregate optical signals.

10. The optical transmitting system of claim 8 further comprising a broadband noise source, wherein the WSS band aggregator is configured to receive broadband noise on one of the inputs and configured to load at least one unutilized channel of the combined aggregate optical signal with at least one spectral portion of the broadband noise using the wavelength selective switching.

11. The optical transmitting system of claim 10 wherein the WSS band aggregator includes a 1×n wavelength selective switch, wherein n corresponds to the number of bands being combined.

12. The optical transmitting system of claim 8 wherein the WSS band aggregator includes a single wavelength selective switch.

13. The optical transmitting system of claim 8 wherein the WSS band aggregator includes a plurality of wavelength selective switches.

14. The optical transmitting system of claim 8 wherein the WSS band aggregator includes first and second redundant WSS band aggregators, and further comprising at least one protection switch for switching from a failed WSS band aggregator to a replacement WSS band aggregator.

15. A line terminating equipment (LTE) system for receiving and transmitting combined aggregate optical signals, the LTE system comprising:
a plurality of transponders configured to transmit and receive optical signals modulated on channel wavelengths, wherein the plurality of channel wavelengths are grouped in a plurality of bands;
a plurality of multiplexers configured to combine transmitted optical signals modulated on the channel wavelengths in respective ones of the bands to produce a plurality of transmitted channel band aggregate optical signals;
a plurality of demultiplexers configured to separate a plurality of received channel band aggregate optical signals, respectively, into received optical signals modulated on the channel wavelengths in respective ones of the bands;
at least one wavelength selective switch (WSS) band aggregator configured to combine the transmitted channel band aggregate optical signals to produce a transmitted combined aggregate optical signal by using wavelength selective switching to route channel wavelengths in each of the transmitted channel band aggregate optical signals to a common output, the transmitted combined aggregate optical signal including the channel wavelengths in the plurality of bands; and
at least one wavelength selective switch (WSS) band deaggregator configured to separate a received combined aggregate optical signal into the plurality of received channel band aggregate optical signals by using wavlength selective switching to route channel wavelengths in the received combined aggregate optical signal to a plurality of outputs.

16. The LTE system according to claim 15, further comprising a broadband noise source, wherein the WSS aggregator is configured to receive broadband noise and configured to load at least one unutilized channel of the combined aggregate optical signal with at least one spectral portion of the broadband noise by using the wavelength selective switching.

17. The LTE system according to claim 16 wherein the WSS band aggregator includes a 1×n wavelength selective switch, wherein n corresponds to the number of bands being combined.

18. The LTE system according to claim 15, wherein the at least one WSS band aggregator includes first and second redundant WSS band aggregators, and further comprising at least one protection switch for switching from a failed WSS band aggregator to a replacement WSS band aggregator.

19. The LTE system according to claim 17, further comprising a fault detector configured to detect an error in the transmitted combined aggregate optical signal output from the WSS band aggregator, the error being indicative of a failure of the WSS band aggregator, wherein the protection switch switches from a failed WSS band aggregator to a replacement WSS band aggregator in response to detecting the error.

20. An optical communication system comprising:
a transmitting terminal configured to transmit a combined aggregate optical signal on a plurality of optical channels within a plurality of bands, the transmitting terminal comprising at least one wavelength selective switch (WSS) band aggregator configured to receive channel band aggregate optical signals on a plurality of inputs, respectively, each of the channel band aggregate optical signals including a plurality of channel wavelengths within an associated one of the bands, and wherein the WSS band aggregator is configured to combine the channel band aggregate optical signals to produce a combined aggregate optical signal by using wavelength selective switching to route channel wavelengths in each of the channel band aggregate optical signals received on the plurality of inputs to an output of the WSS band aggregator, the combined aggregate optical signal including the channel wavelengths in the plurality of bands;
a receiving terminal configured to receive the combined aggregate optical signal, the receiving terminal comprising at least one wavelength selective switch (WSS) band deaggregator configured to separate the combined aggregate optical signal into the plurality of channel band aggregate optical signals by using wavlength selective switching to route channel wavelengths in the combined aggregate optical signal to a plurality of outputs; and
an optical transmission path coupling the transmitting terminal and the receiving terminal.

21. The optical communication system of claim 20 wherein the transmitting terminal further comprises a broadband noise source, wherein the WSS aggregator is configured to receive broadband noise and configured to load at least one unutilized channel of the combined aggregate optical signal with at least one spectral portion of the broadband noise by using the wavelength selective switching.
